(19) United States
(12) Patent Application Publication
(10) Pub. No.: US 2022/0340160 A1
(43) Pub. Date: Oct. 27, 2022

(54) SYSTEMS AND METHODS FOR SIMULATION SUPPORTED MAP QUALITY ASSURANCE IN AN AUTONOMOUS VEHICLE CONTEXT

(71) Applicant: Argo AI, LLC, Pittsburgh, PA (US)

(72) Inventors: Michael Nayhouse, Pittsburgh, PA (US); Thomas Carl Ackenhausen, Ann Arbor, MI (US); Patrick Michael Carmody, Dexter, MI (US)

(21) Appl. No.: 17/236,000

(22) Filed: Apr. 21, 2021

(51) Int. Cl. B60W 60/00; G01C 21/00; B60W 30/09

(52) U.S. Cl. CPC B60W 60/001; G01C 21/3859; B60W 30/09; B60W 2556/40

(57) ABSTRACT

Systems and methods for map quality assurance and/or vehicle control. The methods comprise: generating, by the computing device, a plurality of simulation routes for a vehicle to traverse in a map; simulating, by the computing device, operations of the vehicle along each route of the plurality of simulation routes in the map; analyzing, by the computing device, results from the simulating to validate whether or not a quality of the map is validated; causing, by the computing device, the map to be used to control autonomous or semi-autonomous operations of the vehicle, when a determination is made that the quality of the map is validated; and performing a given operation other than said causing, when a determination is made that the quality of the map is not validated.

### BACKGROUND

### Statement of the Technical Field

The present disclosure relates generally to computing devices. More particularly, the present disclosure relates to implementing systems and methods for simulation supported map quality assurance in an autonomous or semi-autonomous vehicle context.

### Description of the Related Art

Autonomous Vehicles (AVs) have at least one on-board computer and have internet/satellite connectivity. The software running on these on-board computers monitor and/or control operations of the AVs. Operations of the AVs are controlled using High Definition (HD) maps. An HD map is a set of digital files containing data about physical details of a geographic area such as roads, lanes within roads, traffic signals and signs, barriers, and road surface markings. An AV uses HD map data to augment the information that the AV's on-board cameras, LiDAR system and/or other sensors perceive. The AV's on-board processing systems can quickly search map data to identify features of the AV's environment and/or to help verify information that the AV's sensors perceive.

However, maps assume a static representation of the world. Because of this, over time, HD maps can become outdated. Map changes can occur due to new road construction, repaving and/or repainting of roads, road maintenance, construction projects that cause temporary lane changes and/or detours, or other reasons. In some geographic areas, HD maps can change several times per day, as fleets of vehicles gather new data and offload the data to map generation systems. Errors or regressions may be added to the HD maps during the updating thereof. Such errors and regressions can cause an autonomous vehicle to traverse the road/terrain in an unexpected or undesirable manner.

### SUMMARY

The present disclosure concerns implementing systems and methods for map quality assurance and/or vehicle control. The methods comprise performing the following operations by a computing device (e.g., an on-board computing device of the vehicle or a computing device remote from the vehicle (e.g., a server)): generating a plurality of simulation routes for a vehicle to traverse in a map; simulating operations of the vehicle along each route of the plurality of simulation routes in the map; analyzing results from the simulating to determine whether or not a quality of the map is validated; causing the map to be used to control autonomous or semi-autonomous operations of the vehicle, when a determination is made that the quality of the map is validated; and performing a given operation other than said causing, when a determination is made that the quality of the map is not validated.

At least one of the routes comprises (i) a single lane through which the vehicle is to traverse during the simulating or (ii) a plurality of lanes through which the vehicle is to traverse during the simulating. Each said route comprises a start location and an end location which both reside outside of a test lane through which the vehicle is to traverse during the simulating. The quality of the map may be validated, for example, when the vehicle traversed all the simulation routes during the simulating without experiencing a fault of a given type or without having to perform a dangerous maneuver.

In some scenarios, the methods also comprises: selecting a portion of the map to be quality tested based on a current location of the vehicle; discarding or updating the map when a determination is made that the quality of the map is not validated; and/or causing operations of the vehicle to be controlled based on another map when a determination is made that the quality of the map is not validated. The method may be performed responsive to generation of the map, an update to the map, generation of autonomous vehicle software, an update to autonomous vehicle software, an object detection by the vehicle while in use, or a need to generate a vehicle trajectory by the vehicle while in use.

The implementing systems comprise a processor and a non-transitory computer-readable storage medium comprising programming instructions that are configured to cause the processor to implement the method for map quality assurance and/or vehicle control.

### BRIEF DESCRIPTION OF THE DRAWINGS

The present solution will be described with reference to the following drawing figures, in which like numerals represent like items throughout the figures.

FIG. 1 provides an illustration of an illustrative subsection of a road/terrain map that is useful for understanding a route for testing whether an AV can drive over a single lane.

FIG. 2 provides an illustration of an illustrative subsection of a road/terrain map that is useful for understanding a route for testing whether an AV can drive over multiple lanes.

FIG. 3 is an illustration of an illustrative system.

FIG. 4 is an illustration of an illustrative architecture for a vehicle.

FIG. 5 is an illustration of an illustrative architecture for a computing device.

FIG. 6 provides a flow diagram of an illustrative method for providing map quality assurance and/or vehicle control.

FIG. 7 provides a block diagram that is useful for understanding how vehicle control is achieved in accordance with the present solution.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” Definitions for additional terms that are relevant to this document are included at the end of this Detailed Description.

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

The present solution is described herein in the context of an AV. The present solution is not limited to AV applications. The present solution can be used in other applications where HD road/terrain maps are needed to control operations of a device (e.g., a robot).

As noted above, AVs have at least one on-board computer and have internet/satellite connectivity. The software running on these on-board computers monitor and/or control operations of the vehicles. Operations of the vehicles are controlled using HD road/terrain maps. The HD road/terrain maps are generated and updated to reflect road changes (e.g., a new traffic light was installed at an intersection which was previously controlled by stop signs). The HD road/terrain maps may also be updated to include new details which were not previously available. Errors or regressions may be added to the HD road/terrain maps during the updating thereof. Such errors and regressions can cause an AV to traverse the road/terrain in an unexpected or undesirable manner.

The present solution provides systems and methods for ensuring that such errors and regressions have not been added to the HD road/terrain maps during a generation or an updating process. An illustrative method for building or otherwise generating/updating an HD road/terrain map is discussed in U.S. patent application Ser. No. 17/075,827 filed on Oct. 21, 2020. The content of this application is incorporated herein by reference. The HD road/terrain map can be updated to reflect changes in the real environment that is being represented within the map. LiDAR systems, camera systems and/or other means can be used to detect such changes and update the HD road/terrain map in manners known in the art. One of the most difficult parts to test due to time constraints is validating that the AV can drive over the entire terrain covered by the map in an expected manner (i.e., no errors are present in the map which would cause the AV to be unable to traverse the road/terrain as expected).

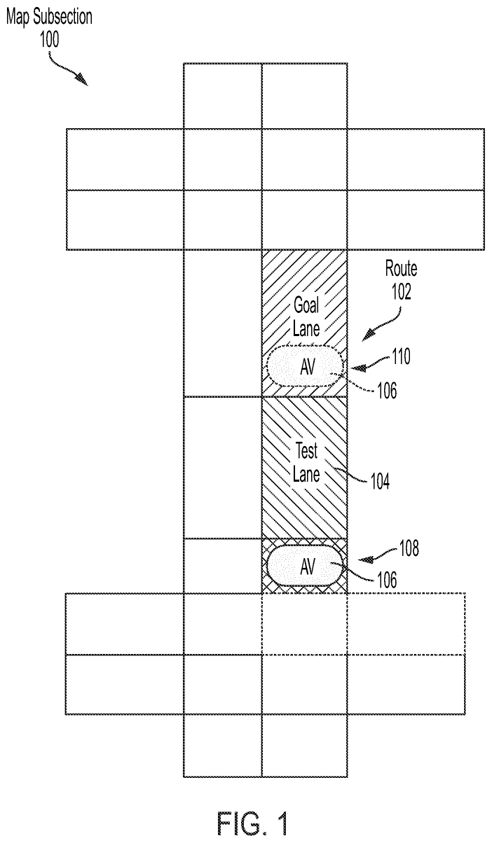

This validation is achieved by automatically creating simulation scenarios using the HD road/terrain map. To be complete as possible, one simulation scenario is generated to test each lane on a road in the map. Each simulation scenario starts the AV at a location prior to the lane being tested, and is assigned a route from the start location, through the test lane, and to an end location beyond the test lane. The assigned route is selected to ensure that the AV can route over the entire lane. An illustrative subsection 100 of a road/terrain map is provided in FIG. 1 that is useful for understanding a route 102 for testing whether an AV 106 can traverse over a single lane 104 in accordance with the present solution. The route 102 comprises a start location 108 and an end location 110, which both reside outside of the lane 104 of interest. When the simulation is run, the computing device determines whether AV 106 can traverse the lane 104 successfully or otherwise in an expected manner.

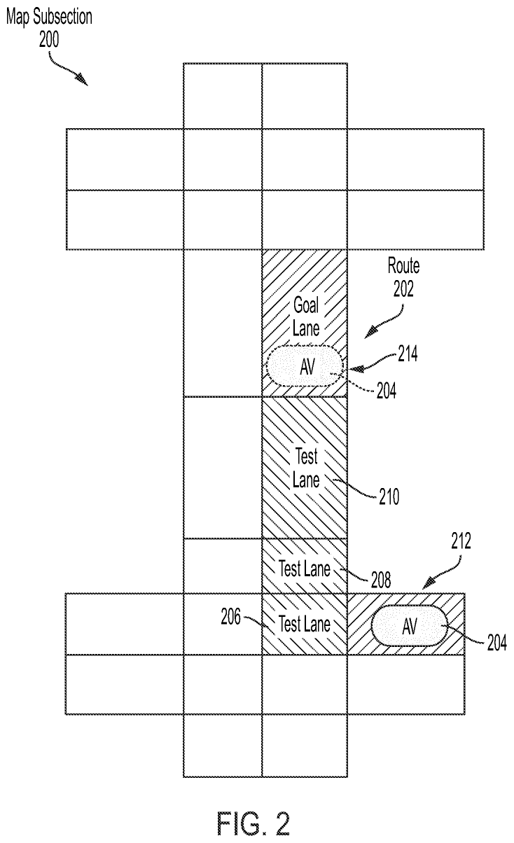

The present solution can be optimized such that two or more lanes can be tested in a single simulation scenario. In this case, checks are put into place in order to track that the AV reaches each lane and successfully routes through the same when all simulation scenarios are considered. An illustrative subsection 200 of a road/terrain map is provided in FIG. 2 that is useful for understanding a route 202 for testing whether an AV 204 can drive over multiple lanes 206, 208, 210 in accordance with the present solution. The route 202 comprises a start location 212 and an end location 214, which both reside outside of the lanes 206-210 of interest. When the simulation is run, the computing device determines whether the AV 204 can traverse the lanes 206-210 successfully or otherwise in an expected manner.

A determination is made that the vehicle can traverse the lane(s) in an expected manner, for example, when the vehicle reaches the end location, there were no or a minimal number of faults (e.g., sensor faults and/or diagnostic faults) of one or more types while traveling along the simulation route or path of travel, the ride comfort was at an acceptable level, any issues experienced while the vehicle traveled along the simulation route or path of travel were minor issues (e.g., ride comfort) rather than major issues (e.g., the vehicle could not traverse the lane(s)) and/or critical issues (e.g., the vehicle performed an emergency maneuver).

In some scenarios, the system tests routes that are not yet approved on specific vehicle software versions. This, for example, could include, but is not limited to, school zones, tunnels, overpasses, railroads, and/or crossings. Additionally or alternatively, the system could test speed limit changes (e.g., map changed speed limit, or an updated AV version of software now allows a higher maximum speed (i.e., up to the speed limit as defined by the HD map)).

Illustrative System

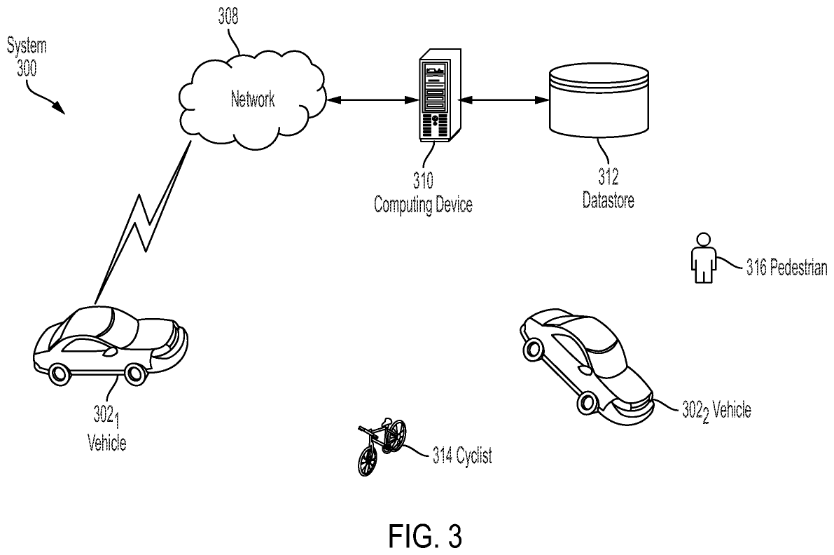

Referring now to FIG. 3, there is provided an illustration of an illustrative system 300. System 300 is configured to (i) automate the creation of simulation scenarios to assist in a map quality assurance process, and (ii) cause AV(s) to be controlled based on quality map(s). System 300 does this in a way that creates small simple scenarios to ensure the entire map or a given portion of the map is covered and tested for quality. The many small scenarios are easily parallelizable to run quickly and efficiently analyze the entire map or given portion of the map.

Testing the quality of a map can be achieved by manually driving the vehicle over the entire map in an autonomous or semi-autonomous mode. However, this is time consuming, may lead to false positives, or differences between map content and the real world lane states (e.g., a lane may be blocked temporarily as the vehicle goes by due to construction for the day). Testing the quality of the map can also be achieved by manually creating scenarios on a new map. This is also time consuming and may lead to incomplete map coverage. Another technique for map quality assurance is to generate a simulated route around an entire map that uses every lane. It takes a long time for the simulated vehicle to traverse the entire map and may also lead to incomplete map coverage if done manually and an error is present in the route.

The present solution employs yet another technique that overcomes the drawbacks of these solutions. In accordance with the present solution, system 300 tests the quality of maps by performing a plurality of simulation scenarios in a sequential or parallel processing manner. Each simulation scenario is designed in an automated fashion to test the quality of one or more lanes of the map. Each simulation scenario has a start location prior to the lane(s) being tested and an end location subsequent to the lane(s) being tested. Once all the simulation scenarios have been performed, then the results of the same are analyzed to determine the overall quality of the map. If the overall quality of the map is acceptable (e.g., a final quality score is greater than a threshold value), then the map is used to control operations of a vehicle (e.g., autonomous driving operations).

As shown in FIG. 3, system 300 comprises a vehicle 302₁ that is traveling along a road in a semi-autonomous or autonomous manner. Vehicle 302₁ is also referred to herein as an AV. The AV 302₁ can include, but is not limited to, a land vehicle (as shown in FIG. 3), an aircraft, a watercraft, or a spacecraft.

AV 302₁ is generally configured to detect objects 302₂, 314, 316 in proximity thereto. The objects can include, but are not limited to, a vehicle 302₂, a cyclist 314 (such as a rider of a bicycle, electric scooter, motorcycle, or the like) and/or a pedestrian 316. The object detection is achieved in accordance with any known or to be known object detection process. The object detection process can be performed at the AV 302₁, at the remote computing device 310, or partially at both the AV 302₁ and the remote computing device 310. Accordingly, information related to object detection may be communicated between the AV and a remote computing device 310 via a network 308 (e.g., the Internet, a cellular network and/or a radio network). The object detection related information may also be stored in a database 312.

When such an object detection is made, AV 302₁ performs operations to: generate one or more possible object trajectories for the detected object; and analyze at least one of the generated possible object trajectories to determine whether or not there is an undesirable level of risk that a collision will occur between the AV and object if the AV is to follow a given trajectory. The given vehicle trajectory is generated by the AV 302₁ using an HD map that has a quality of an acceptable level. The HD map is produced in accordance with any known or to be known map generation and/or updating process. For example, the HD map is produced using 3D laser scan data with dynamic points/objects removed from registered point clouds via ray-casting and semantic class images. The HD map has been quality tested and/or updated as described herein.

If there is not an undesirable level of risk that a collision will occur between the AV and object if the AV is to follow a given trajectory, then the AV 302₁ is caused to follow the given vehicle trajectory. If is an undesirable level of risk that a collision will occur between the AV and object if the AV is to follow a given trajectory, then the AV 302₁ is caused to (i) follow another vehicle trajectory with a relatively low risk of collision with the object or (ii) perform a maneuver to reduce the risk of collision with the object or avoid collision with the object (e.g., brakes and/or changes direction of travel).

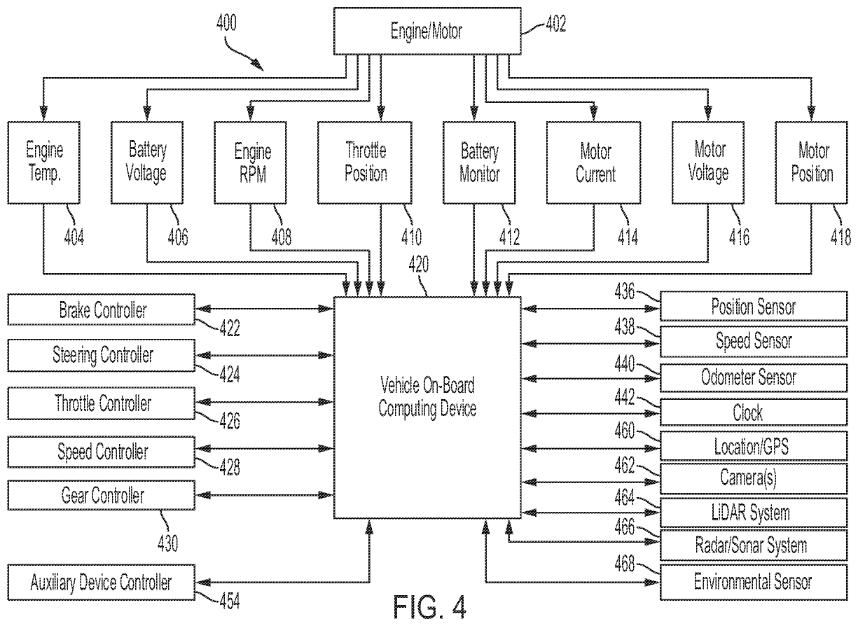

Referring now to FIG. 4, there is provided an illustration of an illustrative system architecture 400 for a vehicle. Vehicles 302₁ and/or 302₂ of FIG. 3 can have the same or similar system architecture as that shown in FIG. 4. Thus, the following discussion of system architecture 400 is sufficient for understanding vehicle(s) 302₁, 302₂ of FIG. 3.

As shown in FIG. 4, the vehicle 400 includes an engine or motor 402 and various sensors 404-418 for measuring various parameters of the vehicle. In gas-powered or hybrid vehicles having a fuel-powered engine, the sensors may include, for example, an engine temperature sensor 404, a battery voltage sensor 406, an engine Rotations Per Minute (RPM) sensor 408, and a throttle position sensor 410. If the vehicle is an electric or hybrid vehicle, then the vehicle may have an electric motor, and accordingly will have sensors such as a battery monitoring system 412 (to measure current, voltage and/or temperature of the battery), motor current 414 and voltage 416 sensors, and motor position sensors such as resolvers and encoders 418.

Operational parameter sensors that are common to both types of vehicles include, for example, a position sensor 436 such as an accelerometer, gyroscope and/or inertial measurement unit, a speed sensor 438, and an odometer sensor 440. The vehicle also may have a clock 442 that the system uses to determine vehicle time during operation. The clock 442 may be encoded into the vehicle on-board computing device, it may be a separate device, or multiple clocks may be available.

The vehicle also will include various sensors that operate to gather information about the environment in which the vehicle is traveling. These sensors may include, for example, a location sensor 460 (e.g., a Global Positioning System (GPS) device), object detection sensors (e.g., camera(s) 462), a LiDAR system 464, and/or a radar/sonar system 466. The sensors also may include environmental sensors 468 such as a precipitation sensor and/or ambient temperature sensor. The object detection sensors may enable the vehicle to detect objects that are within a given distance range of the vehicle 400 in any direction, while the environmental sensors collect data about environmental conditions within the vehicle's area of travel.

During operations, information is communicated from the sensors to an on-board computing device 420. The on-board computing device 420 analyzes the data captured by the sensors and optionally controls operations of the vehicle based on results of the analysis. For example, the on-board computing device 420 may control: braking via a brake controller 422; direction via a steering controller 424; speed and acceleration via a throttle controller 426 (in a gas-powered vehicle) or a motor speed controller 428 (such as a current level controller in an electric vehicle); a differential gear controller 430 (in vehicles with transmissions); and/or other controllers.

Geographic location information may be communicated from the location sensor 460 to the on-board computing device 420, which may then access a map of the environment that corresponds to the location information to determine known fixed features of the environment such as streets, buildings, stop signs and/or stop/go signals. Captured images from the cameras 462 and/or object detection information captured from sensors (e.g., LiDAR system 464) is communicated to the on-board computing device 420. The object detection information and/or captured images are processed by the on-board computing device 420 to detect objects in proximity to the vehicle 400. The object detections are made in accordance with any known or to be known object detection technique.

When the on-board computing device 420 detects a moving object, the on-board computing device 420 will generate one or more possible object trajectories for the detected object, and analyze the possible object trajectories to assess the risk of a collision between the object and the AV if the AV was to follow a given vehicle trajectory. If there is not a risk of collision, then the AV is caused to follow the given vehicle trajectory. If there is a risk of collision, then an alternative vehicle trajectory can be generated and/or the AV can be caused to perform a certain maneuver (e.g., brake, accelerate and/or change direction of travel). The vehicle trajectories are generated using an HD map which is created in accordance with the present solution. The manner in which the HD map is created, updated and/or quality assurance tested are evident from the discussion.

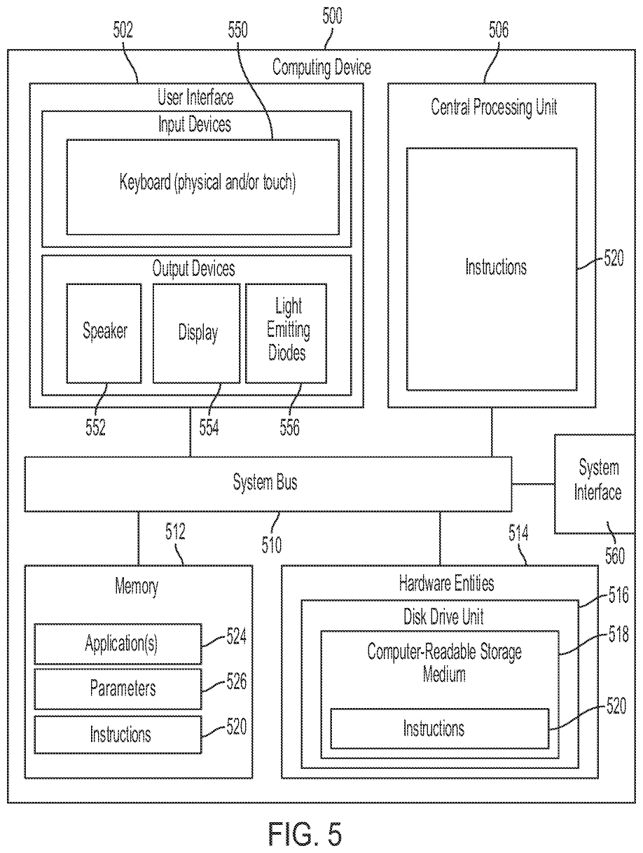

Referring now to FIG. 5, there is provided an illustration of an illustrative architecture for a computing device 500. The computing device 310 of FIG. 3 and/or the vehicle on-board computing device 420 of FIG. 4 is/are the same as or similar to computing device 500. As such, the discussion of computing device 500 is sufficient for understanding the computing device 310 of FIG. 3 and the vehicle on-board computing device 420 of FIG. 4.

Computing device 500 may include more or less components than those shown in FIG. 5. However, the components shown are sufficient to disclose an illustrative solution implementing the present solution. The hardware architecture of FIG. 5 represents one implementation of a representative computing device configured to operate a vehicle, as described herein. As such, the computing device 500 of FIG. 5 implements at least a portion of the method(s) described herein.

Some or all components of the computing device 500 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 5, the computing device 500 comprises a user interface 502, a Central Processing Unit (CPU) 506, a system bus 510, a memory 512 connected to and accessible by other portions of computing device 500 through system bus 510, a system interface 560, and hardware entities 514 connected to system bus 510. The user interface can include input devices and output devices, which facilitate user-software interactions for controlling operations of the computing device 500. The input devices include, but are not limited to, a physical and/or touch keyboard 550. The input devices can be connected to the computing device 500 via a wired or wireless connection (e.g., a Bluetooth® connection). The output devices include, but are not limited to, a speaker 552, a display 554, and/or light emitting diodes 556. System interface 560 is configured to facilitate wired or wireless communications to and from external devices (e.g., network nodes such as access points, etc.).

At least some of the hardware entities 514 perform actions involving access to and use of memory 512, which can be a Random Access Memory (RAM), a disk drive, flash memory, a Compact Disc Read Only Memory (CD-ROM) and/or another hardware device that is capable of storing instructions and data. Hardware entities 514 can include a disk drive unit 516 comprising a computer-readable storage medium 518 on which is stored one or more sets of instructions 520 (e.g., software code) configured to implement one or more of the methodologies, procedures, or functions described herein. The instructions 520 can also reside, completely or at least partially, within the memory 512 and/or within the CPU 506 during execution thereof by the computing device 500. The memory 512 and the CPU 506 also can constitute machine-readable media. The term “machine-readable media”, as used here, refers to a single medium or multiple media (e.g., a centralized or distributed database, and/or associated caches and servers) that store the one or more sets of instructions 520. The term “machine-readable media”, as used here, also refers to any medium that is capable of storing, encoding or carrying a set of instructions 520 for execution by the computing device 500 and that cause the computing device 500 to perform any one or more of the methodologies of the present disclosure.

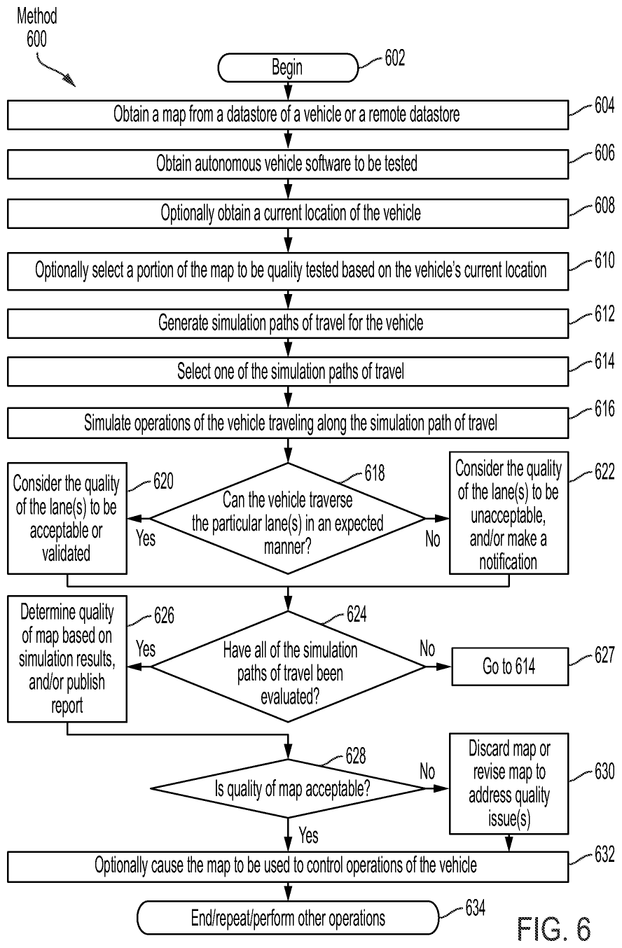

Referring now to FIG. 6, there is provided a flow diagram of an illustrative method 600 for map quality assurance and/or vehicle control. All or some of the operations performed in FIG. 6 can be performed by the on-board computing device (e.g., on-board computing device 420 of FIG. 4) of a vehicle (e.g., AV 302₁ of FIG. 3) and/or a remote computing device (e.g., computing device 310 of FIG. 3).

In scenarios in which a remote computing device (e.g., a server) performs method 600, the remote computing device performs operations to validate a quality of the entire or a portion of the HD map using AV software to simulate operations of the vehicle for traversing the lanes in the HD map. If the quality of the HD map is validated, then the remote computing device can cause operations of the vehicle to be controlled using the validated HD map. Otherwise, the remote computing device can provide a notification and/or report of the validation failure and/or reasons for the validation failure. The simulation process can be performed by the remote computing device when (i) the HD map has been generated or updated, and/or (ii) the AV software has been generated or updated.

In scenarios in which method 600 is performed by the vehicle's on-board computing device, the on-board computing device performs operations to validate the quality of the entire HD map or only a portion of the HD map that is selected based on a current location of the vehicle. If the quality of the HD map or the portion of the HD map is validated, then the on-board computing device causes operations of the vehicle to be controlled using the HD map. Otherwise, the on-board computing device causes the vehicle to be controlled using a previous version of the HD map and/or provide a notification to the remote computing device of the validation failure. The simulation process can be performed by the on-board computing device when (i) the HD map has been generated or updated, (ii) the AV software has been generated or updated, and/or (iii) a trigger event has occurred (e.g., an object detection by the vehicle and/or a vehicle's trajectory needs to be determined).

As shown by FIG. 6, method 600 begins with 602 and continues with 604 where a map is obtained from a datastore of the vehicle (e.g., memory 512 of FIG. 5) or a remote datastore (e.g., datastore 312 of FIG. 3). Software for the vehicle is also obtained in 606 from the datastore local to or remote from the vehicle. The software is configured to cause operations of the vehicle is an autonomous and/or semi-autonomous manner. 604-606 may be initiated, for example, in response to a generation of the map, an updating of the map, a generation of new AV software, an update of AV software, an object detection by the vehicle, and/or other trigger event.

In optional 608, a current location of the vehicle is obtained. For example, the current location is obtained when the vehicle's on-board computing device is performing method 600. The current location can be obtained from a location system of the vehicle (e.g., location system 460 of FIG. 4). The current location can comprise GPS data, triangulation data and/or satellite location data. The current location is used in 610 to select a portion of the map to be quality tested. The size and/or shape of the portion of the map can be pre-defined or dynamically selected based on some criteria. The criteria can include, but is not limited to, a vehicle location, a time of day, a vehicle destination, length of lane(s), and/or estimated times of travel on lane(s). Two or more criteria can be weighted and combined to produce a combined score that is used to identify the portion of the map to be tested or as an input to an algorithm to determine the portion of the map to be tested.

In 612, simulation routes or paths of travel are generated for the vehicle using the map. Each simulation route or path of travel is selected to facilitate the testing of lane(s) in the map during an iteration of a subsequent simulation process. Each simulation route or path of travel includes a start position for the vehicle (may or may not be the current location of the vehicle), at least one particular lane of a plurality of lanes through which the vehicle is to travel, and an end location outside of the particular lane. In some scenarios, one or more simulation paths are generated so that every lane in the map is tested simultaneously, concurrent or sequentially during subsequent simulation processes. In other scenarios, one or more simulation paths are generated so that less than all of the lanes in the map is tested during the subsequent simulation processes. For example, if only a given area of the map has been updated, then the simulation route or paths of travel would include lanes only in this given area of the map or an area of the map that encompasses the given area (e.g., N city blocks, town(s), city(ies), and/or state(s)). Similarly, if the vehicle software has been updated to modify a particular feature or add new feature, then the simulation route or paths of travel would include lanes only in area(s) of the map that is(are) suitable for testing the updated or new feature. The present solution is not limited to the particulars of these examples.

In some scenarios, a simulation route or path of travel is generated to facilitate separate testing of each lane on a road in the map during a plurality of iterations of a simulation process. Each simulation route or path of travel starts driving operations of the vehicle at a start location occurring prior to the lane being tested, causes the vehicle to travel through the lane being tested, and terminates the driving operations at an end location occurring beyond the lane being tested. An illustration showing an illustrative route or path of travel 102 for a test lane 104 is provided in FIG. 1. As shown in FIG. 1, the simulation route or path of travel 102 has a start location 108, passes through the test lane 104, and an end location within a goal lane 110.

In other scenarios, a simulation route or path of travel is generated to facilitate testing of two or more lanes on a road in the map during each of a plurality of iterations of the simulation process. The iterations can be performed simultaneously, concurrent or sequentially. Each simulation route or path of travel starts driving operations of the vehicle at a start location occurring prior to the lane being tested, causes the vehicle to travel through two or more lanes being tested, and terminates the driving operations at an end location occurring beyond the lanes being tested. An illustration showing an illustrative route or path of travel 202 for test lanes 206, 208, 210 is provided in FIG. 2. As shown in FIG. 2, the simulation route or path of travel 202 has a start location 212, passes through the test lanes 206, 208, 210, and an end location within a goal lane 214.

Referring again to FIG. 6, method 600 continues with 614 where a simulation route or path of travel is selected. This selection can be arbitrary, in accordance with a specific order (e.g., order of generation), and/or in accordance with an algorithm (e.g., a random or pseudo-random algorithm). An identifier for the map, an identifier for a given area of the map and/or identifier(s) for lane(s) that is(are) being analyzed can be used as seed value(s) to the algorithm.

Next in 616, the vehicle software is used to simulate operations of the vehicle traveling along the selected simulation route or path of travel. Upon completion of the simulation operations, the system determines whether the vehicle can traverse the particular lane(s) in an expected manner.

A determination is made that the vehicle can traverse the lane(s) in an expected manner when the vehicle reaches the end location, there were no or a minimal number of faults (e.g., sensor faults and/or diagnostic faults) of one or more types while traveling along the simulation route or path of travel, the ride comfort was at an acceptable level, any issues experienced while the vehicle traveled along the simulation route or path of travel were minor issues (e.g., ride comfort) rather than major issues (e.g., the vehicle could not traverse the lane(s)) and/or critical issues (e.g., the vehicle performed an emergency driving operation).

A determination is made that the vehicle cannot transverse the lane(s) in the expected manner when the vehicle did not reach the end location, faults (e.g., sensor faults and/or diagnostic faults) of one or more types occurred as the vehicle was traversing the lane(s), ride comfort was at an unacceptable level, the vehicle took an evasive or emergency maneuver to avoid an obstacle, and issues experienced while the vehicle traveled along the simulation route or path of travel were major and/or critical issues.

If so [618:YES], then the quality of the tested lane(s) is(are) deemed or otherwise considered good, acceptable, satisfactory and/or validated as shown by 620. If not [618:NO], then the quality of the lane(s) is(are) deemed or otherwise considered poor, unacceptable, unsatisfactory and/or invalidated as shown by 622. A notification in a report can be made in 622 indicating the validation failure for the respective lane(s) in the map.

Subsequent to completing 620 or 622, a determination is made as to whether all of the simulation routes or paths of travel have been evaluated. If not [624:NO], then method 600 returns to 614 so that the simulation process is repeated for a next simulation route or path of travel as shown by 627.

If so [624:YES], then the overall quality of the map is determined in 626. The map may be considered to be of a good quality, an acceptable quality, a satisfactory quality and/or a validated quality when, for example, the vehicle traversed all the lane(s) that were tested without experiencing any faults of given types or a minimal number of faults of the given type (e.g., less than X minor issues occur, where X is a threshold value determined based on historical data, and zero major or critical issues occur) and/or without having to perform a dangerous and/or emergency maneuver. The map is considered to be of a bad quality, an unacceptable quality, an unsatisfactory quality and/or invalidated quality when, for example, the vehicle was unable to traverse at least one of the lane(s) that were tested, experienced one or more faults of given types (e.g., more than or equal to X minor issues occur, where X is a threshold value determined based on historical data, and/or if any major or critical issues occur), and/or performed one or more emergency operations (e.g., swerved, took a sharp turn into traffic, and/or performed an emergency maneuver to avoid an obstacle).

A report and/or other information may be published in 626 indicating the determined overall quality of the map and/or quality of the lane(s). If the quality of the map is poor/unacceptable/unsatisfactory/invalidated [628:NO], then the map is discarded or the map is revised to improve its overall quality as shown by 630. The map may be revised on newly acquired sensor data (e.g., data generated by sensor(s) 462, 464, 466 of the vehicle or other vehicle(s)). Thereafter, method 600 continues with optional 632 (e.g., so that the revised map can be used to control operations of the vehicle) or 634 which will be described below.

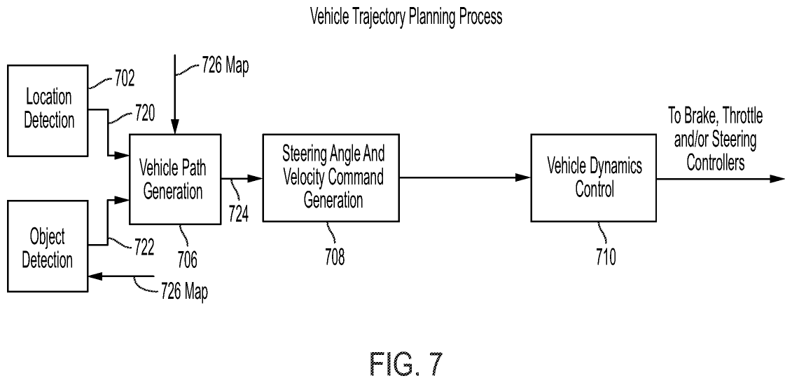

If the quality of the map is good/acceptable/satisfactory/validated [628:YES], then the map is optionally used to control operations of the vehicle (e.g., as described below in relation to FIG. 7). Subsequently, 634 is performed where method 600 ends, repeats or other operations are performed.

As noted above, the map can be used by an AV for object trajectory prediction, vehicle trajectory generation, and/or collision avoidance. A block diagram is provided in FIG. 7 that is useful for understanding how vehicle control is achieved in accordance with the present solution. The operations of FIG. 7 can be performed in 632 of FIG. 6. All or some of the operations performed in FIG. 7 can be performed by the on-board computing device (e.g., on-board computing device 420 of FIG. 4) of a vehicle (e.g., AV 302₁ of FIG. 3) and/or a remote computing device (e.g., computing device 310 of FIG. 3).

In block 702, a location of the vehicle is detected. This detection can be made based on sensor data output from a location sensor (e.g., location sensor 460 of FIG. 4) of the vehicle. This sensor data can include, but is not limited to, GPS data. Information 720 specifying the detected location of the vehicle is then passed to block 706.

In block 704, an object is detected within proximity of the vehicle. This detection is made based on sensor data output from a camera (e.g., camera 462 of FIG. 4) of the vehicle. Any known or to be known object detection technique can be used here. Information about the detected object 722 is passed to block 706. This information includes, but is not limited to a position of an object, an orientation of the object, a spatial extent of the object, an initial predicted trajectory of the object, a speed of the object, and/or a classification of the object. The initial predicted object trajectory can include, but is not limited to, a linear path pointing in the heading direction of the object. The initial predicted trajectory of the object can be generated using a HD map 726 (or final 3D point cloud) which was determined to have a given level of quality (e.g., as described above in relation to FIG. 6).

In block 706, a vehicle trajectory is generated using the information from blocks 702 and 704, as well as the HD map 726. Techniques for determining a vehicle trajectory are well known in the art. Any known or to be known technique for determining a vehicle trajectory can be used herein. For example, in some scenarios, such a technique involves determining a trajectory for the AV that would pass the object when the object is in front of the AV, the object has a heading direction that is aligned with the direction in which the AV is moving, and the object has a length that is greater than a threshold value. The present solution is not limited to the particulars of this scenario. The vehicle trajectory 724 can be determined based on the location information 720, the object detection information 722, and/or the HD map 726 which is stored in a datastore of the vehicle. The vehicle trajectory 724 may represent a smooth path that does not have abrupt changes that would otherwise provide passenger discomfort. For example, the vehicle trajectory is defined by a path of travel along a given lane of a road in which the object is not predicted to travel within a given amount of time. The vehicle trajectory 724 is then provided to block 708.

In block 708, a steering angle and velocity command is generated based on the vehicle trajectory 724. The steering angle and velocity command is provided to block 710 for vehicle dynamics control. Vehicle dynamics control is well known. The vehicle dynamics control cause the vehicle to follow the vehicle trajectory 724.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A method for map quality assurance, comprising:
generating, by the computing device, a plurality of simulation routes for a vehicle to traverse in a map;
simulating, by the computing device, operations of the vehicle along each route of the plurality of simulation routes in the map;
analyzing, by the computing device, results from the simulating to determine whether or not a quality of the map is validated;
causing, by the computing device, the map to be used to control autonomous or semi-autonomous operations of the vehicle, when a determination is made that the quality of the map is validated; and
performing a given operation other than said causing, when a determination is made that the quality of the map is not validated.

2. The method according to claim 1, wherein the computing device comprises an on-board computing device of the vehicle or a computing device remote from the vehicle.

3. The method according to claim 1, further comprising selecting a portion of the map to be quality tested based on a current location of the vehicle.

4. The method according to claim 1, wherein each said route comprises a single lane through which the vehicle is to traverse during the simulating.

5. The method according to claim 1, wherein each said route comprises a plurality of lanes through which the vehicle is to traverse during the simulating.

6. The method according to claim 1, wherein each said route comprises a start location and an end location which both reside outside of a test lane through which the vehicle is to traverse during the simulating.

7. The method according to claim 1, wherein the quality of the map is validated when the vehicle traversed all the simulation routes during the simulating without experiencing a fault of a given type or without having to perform a dangerous maneuver.

8. The method according to claim 1, wherein the given operation comprises discarding or updating the map.

9. The method according to claim 1, wherein the given operation comprises causing operations of the vehicle to be controlled based on another map.

10. The method according to claim 1, wherein the method is performed responsive to generation of the map, an update to the map, generation of autonomous vehicle software, an update to autonomous vehicle software, an object detection by the vehicle while in use, or a need to generate a vehicle trajectory by the vehicle while in use.

11. A system, comprising:
a processor;
a non-transitory computer-readable storage medium comprising programming instructions that are configured to cause the processor to implement a method for map quality assurance, wherein the programming instructions comprise instructions to:
generate a plurality of simulation routes for a vehicle to traverse in a map;
simulate operations of the vehicle along each route of the plurality of simulation routes in the map;
analyze results from the simulating to determine whether or not a quality of the map is validated;
cause the map to be used to control autonomous or semi-autonomous operations of the vehicle, when a determination is made that the quality of the map is validated; and
perform a given operation when a determination is made that the quality of the map is not validated.

12. The system according to claim 11, wherein the system comprises an on-board computing device of the vehicle or a computing device remote from the vehicle.

13. The system according to claim 11, wherein the programming instructions further comprise instructions to select a portion of the map to be quality tested based on a current location of the vehicle.

14. The system according to claim 11, wherein each said route comprises a single lane through which the vehicle is to traverse during the simulating.

15. The system according to claim 11, wherein each said route comprises a plurality of lanes through which the vehicle is to traverse during the simulating.

16. The system according to claim 11, wherein each said route comprises a start location and an end location which both reside outside of a test lane through which the vehicle is to traverse during the simulating.

17. The system according to claim 11, wherein the quality of the map is validated when the vehicle traversed all the simulation routes during the simulating without experiencing a fault of a given type or without having to perform a dangerous maneuver.

18. The system according to claim 11, wherein the given operations comprises discarding or updating the map when the quality of the map is not validated.

19. The system according to claim 11, wherein the given operation comprises causing operations of the vehicle to be controlled based on another map when a determination is made that the quality of the map is not validated.

20. The system according to claim 11, wherein the method is performed responsive to generation of the map, an update to the map, generation of autonomous vehicle software, an update to autonomous vehicle software, an object detection by the vehicle while in use, or a need to generate a vehicle trajectory by the vehicle while in use.
